(19) United States
(12) Patent Application Publication
(10) Pub. No.: US 2011/0081457 A1
(43) Pub. Date: Apr. 7, 2011

(54) Roasted barley, barley tea bags using the same and method of producing roasted barley

(75) Inventors: Kazunobu Tsuru, Shizuoka (JP); Kengo Hida, Shizuoka (JP); Yasuhiro Haraguchi, Shizuoka (JP); Masashige Taniguchi, Shizuoka (JP)

(73) Assignee: ITO EN, LTD

(21) Appl. No.: 12/923,570

(22) Filed: Sep. 28, 2010

Related U.S. Application Data
(63) Continuation-in-part of application No. PCT/JP2009/057713, filed on Apr. 10, 2009.

(30) Foreign Application Priority Data
May 23, 2008 (JP) 2008-135938

(51) Int. Cl. A23L 1/182; A23B 9/02; B65B 29/02; A23F 3/00; A47J 37/00

(52) U.S. Cl. 426/77; 426/627; 426/466; 426/461; 426/597; 99/345

(57) ABSTRACT

The present invention provides roasted barley from which barley tea having excellent aroma, sweetness and richness and so on can be extracted. Roasted barley characterized by having a measured void content of 1.5 ml to 2.5 ml. The above-described roasted barley can be produced by a production method which involves a rapid cooling step, wherein the material temperature of barley is rapidly lowered to 60 to 130° C. within 5 seconds, between a primary roasting step and a secondary roasting step. It is preferred to further employ a slow cooling step, wherein the material temperature of the barley is maintained at 80 to 140° C. over 16 to 120 seconds, after the secondary roasting step.

### CROSS-REFERENCE TO RELATED APPLICATIONS

This application is a Continuation in Part of the U.S. national phase of PCT/JP2009/057713 filed Apr. 10, 2009; which claims priority from Japanese Application No. 2008-135938 filed May 23, 2008. The subject matter of each of the above-referenced applications is incorporated in entirety by reference.

### TECHNICAL FIELD

The present invention relates to roasted barley for barley tea extraction, and more particularly, to roasted barley appropriate for tea bags, and a method of producing the roasted barley.

### BACKGROUND ART

Barley tea is a beverage produced by roasting barley as a raw material, and extracting the roasted barley directly or after grinding.

In recent years, “tea bag barley tea” has been popularized, which allows a ground product of roasted barley enclosed in a bag to be extracted with hot water, water or the like. Since such “tea bag barley tea” is made such that the amount of tea that can be included in the bag is limited and the included tea is briefly extracted with hot water, water or the like, the barley tea extracted thereby is poor in the aroma, taste, color and the like, as compared with the case where the barley tea is decocted in boiling water over a sufficient time.

Thus, there have been developed methods of roasting barley that can be extracted into a barley tea having excellent aroma, taste, color and the like even if made into “tea bag barley tea.” For example, a production method which is steaming the raw material barley and roasting the barley in two divided portions (see the following Patent Document 1); a production method which is mixing a barley for coloring that has been roasted and then rapidly subjected to a cooling treatment to prevent burning, with a barley for flavoring that has been subjected to a light roasting treatment (see the following Patent Document 2); a production method which is roasting barley without burning, by adjusting the heating temperature while spraying water thereover (see the following Patent Document 3); and the like are available.

[Patent Reference 1]: Japanese Patent Application Laid-Open No. 2000-245411

[Patent Reference 2]: Japanese Patent Application Laid-Open No. H6-46808

[Patent Reference 3]: Japanese Patent Application Laid-Open No. H9-65861

### DISCLOSURE OF INVENTION

### Problem to be Solved by the Invention

It is a general practice to perform heavy (deep) roasting in order to make the top note (impact) strong; however, when the roasting is carried out strongly, a characteristic roasting aroma (smoky odor and burnt odor) may be generated, or an acrid taste or a bitter taste may be generated. On the other hand, in order to impart a sweet taste or a rich taste, the sweet taste or richness inherent to the raw material is retained by performing light roasting.

In order to combine the characteristics of both of these techniques, heavy-roasted products and light-roasted products that have been produced in separate processes are being blended or the like, as described in the Patent Document 2. However, such a production method necessitates processes for producing a heavy-roasted product and a light-roasted product, or a process of blending the products, which make the production method deteriorated in the production efficiency.

Therefore, it is an object of the present invention to provide roasted barley from which a barley tea excellent in the aroma, sweetness, richness and the like can be extracted, and to provide a method of producing roasted barley, which can extract a barley tea excellent in the aroma, sweetness, richness and the like only by roasting, without blending plural kinds of roasted barley.

### Means for Solving Problem

The grain of roasted barley of the present invention is characterized in that the measured void content per grain is 1.5 mL to 2.5 mL.

Such roasted barley allows extraction of a barley tea excellent in the aroma, sweetness and richness, and the like. This is believed to be because the inner part of barley swells and is brought into a state of being tightened hard, and the barley is close to the state of being roasted uniformly from the surface to the inside.

The method of producing roasted barley of the present invention is characterized by including, between a primary roasting step and a secondary roasting step, at least a rapid cooling step of rapidly lowering the material temperature of barley over a temperature difference of 60 to 130° C. within 5 seconds.

As such, when a rapid cooling step is added between the primary roasting step and the secondary roasting step in the method of producing roasted barley by roasting two times, roasted barley from which a barley tea having excellent aroma, sweetness, richness and the like can be extracted can be produced.

### BRIEF DESCRIPTION OF DRAWINGS

The patent or application file contains at least one drawing executed in color. Copies of this patent or patent application publication with color drawing(s) will be provided by the Office upon request and payment of necessary fee.

FIG. 1 is a photograph showing a cross-sectional view of the roasted barley of Example 1;

FIG. 2 is a photograph showing a cross-sectional view of the roasted barley of Comparative Example 1;

FIG. 3 is a photograph showing a cross-sectional view of the roasted barley of Comparative Example 2;

FIG. 4 is a photograph showing a cross-sectional view of the roasted barley of Comparative Example 3; and

FIG. 5 is a schematic cross-sectional view showing a freeness tester for measuring the freeness.

### BEST MODE(S) FOR CARRYING OUT THE INVENTION

Hereinafter, the present invention will be described based on a suitable embodiment. However, the present invention is not intended to be limited to this embodiment.

The roasted barley of one embodiment of the present invention is characterized in that the measured void content is 1.5 mL to 2.5 mL, preferably 1.7 mL to 2.3 mL, and more preferably 1.8 mL to 2.2 mL.

For the barley used in the present invention, all kinds of barley can be used, irrespective of the breed variety such as Hordeum distichum or Hordeum vulgare, or the presence or absence of the husk.

The measured void content as used in the present invention can be calculated as follows.

The weight of one grain of barley, X (g), was measured, subsequently the bulk specific gravity per 100 g of the barley used (ml/100 g) was measured, and thereby the bulk specific gravity per 1 g, Y (ml/g), was calculated. Then, the apparent volume per grain, Z (ml/grain), is calculated from the following calculation formula (1).

Z=(X×Y) (1)

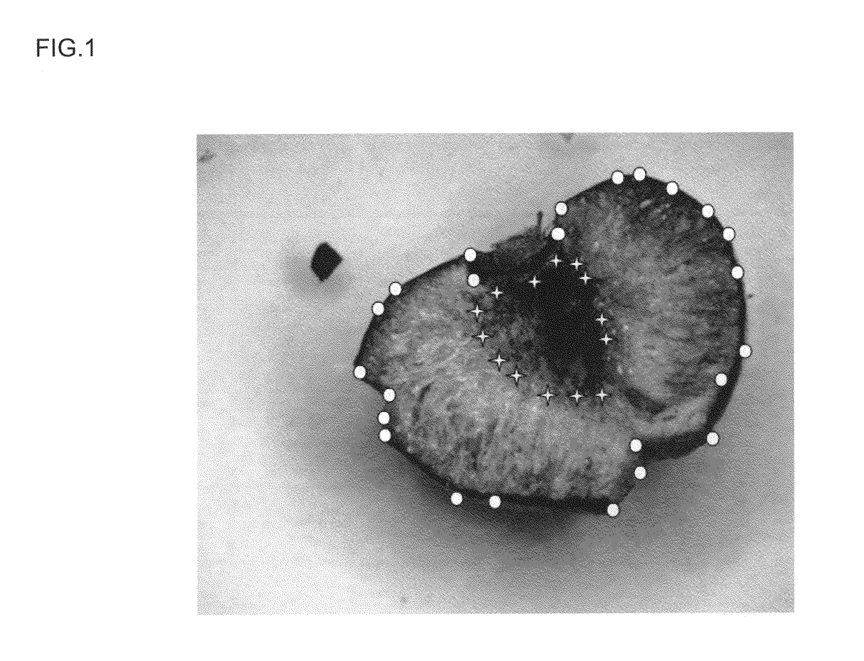

Then, a roasted barley grain is cut perpendicularly at the midpoint of the major axis, and the total area of the cross-section, A, and the area of the voids inside, B, are calculated. The calculation of the area A and the area B can be carried out by plotting the circumference of the barley (symbol ◯) and the circumference of voids (star symbol) in the photograph of cross-section, and defining the ranges, using a personal computer or the like as shown in FIG. 1. Specifically, image processing is carried out with a software program called “BSD8000 (trade name)”, and thereby the area of voids can be measured.

Then, the measured void content C can be calculated from the following calculation formula (2).

C=(B/A)×100×Z (2)

It is preferable to calculate the measured void content by randomly selecting three or more grains, and preferably five or more grains, of the roasted barley.

It is preferable that the roasted barley of the present invention have a hardness per grain of 1.7 kg to 2.3 kg, and particularly preferably 1.9 kg to 2.1 kg.

When the hardness is in this range, the inner part of the barley swells and is brought to a state of being tightened hard, and the barley has been roasted evenly from the surface to the inside. When the hardness is less than 1.7 kg, the sweetness and richness are insufficient, and when the hardness is greater than 2.3 kg, the top note becomes weak.

This hardness can be measured by interposing one grain of roasted barley between metal plates, continuously applying a load, and measuring the load when a bursting sound is heard.

The roasted barley of the present invention is preferably such that the difference between the L value of the whole material (unground material) and the L value of the ground material is 6.5 or less, and particularly preferably 6.0 or less.

When the difference in the L value is in this range, the unevenness of roasting is little, and a barley tea having the roasted savor and sweetness can be extracted. When the difference in the L value exceeds 6.5, it is difficult for the barley tea to have both the sweetness/richness and the roasted savor.

This difference in the L value can be determined by, for example, calculating the difference between the L value obtained by enclosing a whole material of roasted barley in a measurement cell and measuring the value with a colorimeter (specifically, NIPPON DENSHOKU SE-2000 manufactured by Nippon Denshoku Industries Co., Ltd., or the like), and the L value obtained by grinding 10 g of a whole material of roasted barley for 3 seconds with a hand mill (specifically, laboratory mixer LM-1, or the like), enclosing the ground material evenly in a measurement cell and measuring the value with a colorimeter.

The roasted barley of the present invention can be produced by, for example, subjecting barley to a primary roasting step, a rapid cooling step, a secondary roasting step, and a slow cooling step. In regard to the rapid cooling step and the slow cooling step, it is preferable for the production method to include both of the steps, but a production method of carrying out only the rapid cooling step may still be acceptable.

The primary roasting step is a step of performing roasting using a rotary drum-type medium roasting furnace or the like, and it is preferable to perform roasting at a roasting temperature of 225° C. to 290° C., and preferably 235° C. to 260° C., for 60° C. to 120 seconds, and preferably 80 seconds to 100 seconds, though without being limited thereto. When the temperature is 225° C. or higher, the barley is easily expanded, and when the temperature is 290° C. or lower, the barley becomes more stable during the secondary roasting. Furthermore, when the roasting time is 60 seconds or longer, heat is transferred to the inside, and when the roasting time is 120 seconds or shorter, the unevenness of roasting hardly occurs.

It is preferable to adjust the water content of barley to 14% to 30%, and preferably 20% to 28%, and also to expand the volume by 1% to 20%, by subjecting the barley to be used to a steam spray treatment before the primary roasting step. The steam spray treatment can be carried out, for example, for a steam spraying time of 5 seconds to 60 seconds at a steam flow rate of 20 kg/hr to 60 kg/hr. When the water content of barley is 14% or greater, a burnt deposit is hardly generated, and when the water content is 30% or less, roasting unevenness hardly occurs.

The rapid cooling step is a step of cooling the material temperature of barley over a temperature difference of 60° C. to 130° C., and preferably 80° C. to 90° C., within 5 seconds, and can be carried out by, for example, spraying water, hot water or steam or by spraying a cold gas such as liquid nitrogen, on the barley that has been subjected to primary roasting. The temperature can be lowered to a predetermined temperature by adjusting the amount of water or the like to be sprayed or the amount of the cold gas to be sprayed. When the barley is cooled within 5 seconds, ideal pores can be obtained, and when the temperature difference is within 130° C., the flavor is further improved.

The L value (color tone) of barley prior to carrying out the rapid cooling step is preferably 30 to 80, and particularly preferably 40 to 75, and thereby a barley tea having a roasted savor and sweetness can be obtained.

In the secondary roasting step, it is preferable to perform roasting at a roasting temperature of 250° C. to 300° C., and preferably 265° C. to 290° C., for 60 seconds to 120 seconds, and preferably 80 seconds to 100 seconds, though without being limited thereto. When the roasting temperature is 250° C. or higher, the barley acquires a roasted savor, and when the roasting temperature is 300° C. or lower, stable roasted barley can be obtained.

The slow cooling step is a step of retaining the material temperature of barley at 80° C. to 140° C. for 16 seconds to 120 seconds, and preferably 27 seconds to 60 seconds, and the material temperature and retention time of barley can be adjusted by, for example, transferring the barley that has been subjected to secondary roasting to the conveyor of a cooling apparatus, adjusting the speed of the conveyor and also adjusting a cooling fan or the like or spraying a temperature-regulated gas. When the retention time is 16 seconds to 120 seconds, the barley has enhanced sweetness and richness, and also has the flavor stabilized.

The L value (color tone) of barley prior to carrying out the slow cooling step is preferably 15 to 65, and particularly preferably 20 to 40. When the L value is 15 or higher, the barley has less bitter taste, and when the L value is 65 or lower, the barley has a roasted savor.

The L value can be obtained by, for example, grinding 10 g of roasted barley for 20 seconds with a hand mill (specifically, laboratory mixer LM-1, or the like), inserting the ground barley in a cell, mixing the barley evenly in the cell, and then measuring the value with a colorimeter (specifically, NIPPON DENSHOKU SE-2000 manufactured by Nippon Denshoku Industries Co., Ltd. or the like).

The roasted barley thus produced has the internal voids tightened very hard as compared with conventional roasted barley products, and the barley tea extracted using this roasted barley is excellent in the aroma, sweetness and richness. Particularly, when used in tea bags or the like, the roasted barley is excellent in the sensory aspect as compared with conventional roasted barley products, and the roasted barley can give an aroma, sweetness and richness even in a small amount and can contribute to a reduction in waste materials. Furthermore, since the production method of the present invention does not require a step of blending a heavy-roasted product and a light-roasted product, the production efficiency can be increased.

When there is constructed an apparatus for producing roasted barley including a primary roasting chamber in which primary roasting is performed so as to obtain an L value of barley of 30 to 80, and a secondary roasting chamber in which secondary roasting is performed so as to obtain an L value of barley of 15 to 65; or an apparatus for producing roasted barley including a primary roasting chamber in which primary roasting is performed at a roasting temperature of 225 to 290° C. for 60 to 120 seconds, a secondary roasting chamber in which secondary roasting is performed at a roasting temperature of 250 to 300° C. for 60 to 120 seconds, and near the outlet of this primary roasting chamber or outside the primary roasting chamber, a liquid or gas spraying apparatus for performing rapid cooling, the roasted barley can be easily produced using the production method described above.

It is preferable that the apparatus for producing roasted barley further include a steam spray treatment chamber in which the raw material barley is subjected to a steam spray treatment to adjust the water content of barley to 14% to 30%, and also to expand the volume by 1% to 20%.

The roasted barley or a product obtained by grinding the roasted barley (ground product) can be enclosed in a filter and made into a tea bag. The tea bag having the roasted barley or a ground product thereof enclosed therein can be extracted with any of hot water, normal temperature water and cold water. Furthermore, the roasted barley or a ground product thereof can be enclosed in all kinds of filters, as long as the filters do not impede extraction of these products. However, in order to make efficient extraction possible, that is, to improve the extraction efficiency or to allow an extraction within a short time, it is more preferable to select an appropriate filter for the roasted barley contained therein.

For example, a filter made of a material having a freeness of 2.0 seconds to 25.0 seconds, and among other things, 7.0 seconds to 24.0 seconds, is preferred.

The freeness can be measured by a method that will be shown in the following Examples, or the like.

Barley tea can be produced by extracting the roasted barley or a ground product thereof with hot water or the like, and this barley tea can be filled in a container to produce a barley tea beverage packaged in a container. The extraction of barley tea can be carried out by a conventional production method. The container to be filled is not particularly limited, and for example, a plastic bottle (so-called PET bottle), a metal can made of steel or aluminum, a bin, a paper container and the like can be used. In particular, a transparent container such as a PET bottle can be preferably used with preference.

### EXAMPLE

Hereinafter, the Examples of the present invention will be described. However, the present invention is not intended to be limited to these Examples.

### Example 1

Barley that was used as a raw material was subjected to a steam spray treatment to adjust the moisture content to about 25% by weight, and this barley was fed into a rotary drum-type medium roasting furnace, in which primary roasting was performed at a roasting temperature of 255° C. for 90 seconds. Thereafter, water was sprayed in a shower form at a rate of 0.17 L/minute, and the temperature was instantaneously (about 1 second) decreased to 90° C. to rapidly cool the barley so as to bring the material temperature of the barley down to 165° C. Subsequently, secondary roasting was performed at a roasting temperature of 280° C. for 90 seconds, and this roasted barley was transferred to the conveyor of a cooling apparatus. The barley was subjected to slow cooling by adjusting the cooling fan and the speed of the conveyor so as to retain the material temperature of the barley in a temperature range of 80 to 140° C. for 47 seconds, and thus roasted barley was produced.

The bulk specific gravity of 100 g of the roasted barley thus produced was measured. Furthermore, 5 grains were arbitrarily selected, and the weight of each grain was measured. At the same time, the roasted barley was cut perpendicularly at the midpoint of the major axis, and the measured void content was calculated. The results are presented in Table 1, and a photograph of the cross-section is presented in FIG. 1.

The hardness indicated in the table was measured using a hardness meter (Product Model: FUDOH RHEOMETER RT-2010)-CW) manufactured by Yokogawa Electric Corp., with the T-speed set up at 6 mm/min, the stroke at 10 mm and the base line at 60, by mounting one grain of roasted barley on the measurement stand formed from a metal plate, elevating the measurement stand to thereby interpose the barley grain between the measurement stand and a metal plate disposed above, stopping the elevation of the measurement stand at a time point at which a sound of the roasted barley bursting is heard, and reading the value at the time point (the same applies to the following Comparative Examples).

TABLE 1
Example 1
Average weight (g/grain) 0.034
Apparent volume (ml/grain) 0.122

| | Cross- | Cross- | | Occupancy | |
|---|---|---|---|---|---|
| | sectional | sectional | | of air holes | |
| | area of the | area of | | covering in | Measured |
| | entirety | air holes | | the entirety | void |
| No. | (μm²) | (μm²) | Hardness | (%) | content |
| 1 | 9644593 | 1224749 | 1.7 kg | 12.70 | 1.5 |
| 2 | 8824924 | 1543263 | 2.1 kg | 17.49 | 2.1 |
| 3 | 9113412 | 1441115 | 1.9 kg | 15.81 | 1.9 |
| 4 | 9019661 | 1718718 | 2.3 kg | 19.05 | 2.3 |
| 5 | 8988734 | 1437747 | 1.9 kg | 15.99 | 2.0 |
| Ave | 9118265 | 1473118 | 2.0 kg | 16.01 | 2.0 |

### Comparative Example 1

Barley that was used as a raw material was subjected to a steam spray treatment to adjust the moisture content to about 25% by weight, and this barley was fed into a rotary drum-type medium roasting furnace, in which primary roasting was performed at a roasting temperature of 255° C. for 90 seconds. Subsequently, secondary roasting was performed at a roasting temperature of 280° C. for 90 seconds, and the roasted barley was transferred to the conveyor of a cooling apparatus. The barley was subjected to slow cooling by adjusting the cooling fan and the speed of the conveyor so as to retain the material temperature of the barley in a temperature range of 80 to 140° C. for 13 seconds, and thus roasted barley was produced.

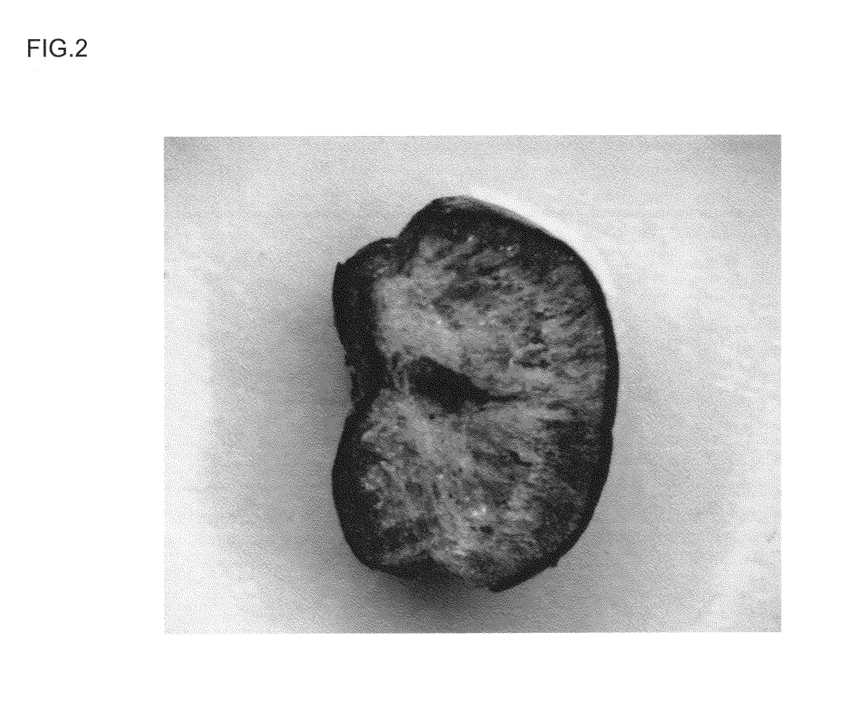

The bulk specific gravity of 100 g of the roasted barley thus produced was measured. Furthermore, 5 grains were arbitrarily selected, and the weight of each grain was measured. At the same time, the roasted barley was cut perpendicularly approximately at the center, and the measured void content was calculated. The results are presented in Table 2, and a photograph of the cross-section is presented in FIG. 2.

TABLE 2
Comparative Example 1
Average weight (g/grain) 0.032
Apparent volume (ml/grain) 0.118

| | Cross- | Cross- | | Occupancy | |
|---|---|---|---|---|---|
| | sectional | sectional | | of air holes | |
| | area of the | area of | | covering in | Measured |
| | entirety | air holes | | the entirety | void |
| No. | (μm²) | (μm²) | Hardness | (%) | content |
| 1 | 9448196 | 274685 | 1.1 kg | 2.91 | 0.3 |
| 2 | 9533504 | 424550 | 1.0 kg | 4.45 | 0.5 |
| 3 | 5981208 | 131650 | 0.9 kg | 2.20 | 0.3 |
| 4 | 7627899 | 127761 | 0.9 kg | 1.67 | 0.2 |
| 5 | 5951847 | 393221 | 1.1 kg | 6.61 | 0.8 |
| Ave | 7708531 | 270373 | 1.0 kg | 3.57 | 0.4 |

### Comparative Example 2

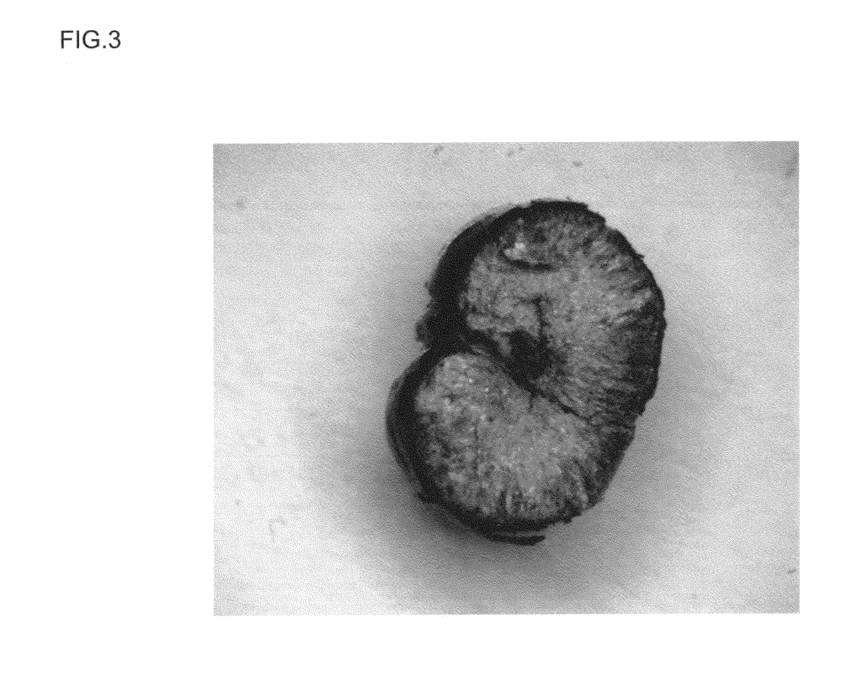

A package of 30 g×12 bags of “Marutsubu Barley Tea” manufactured by Hakubaku Co., Ltd., which is a commercially available product, was used, and the bulk specific gravity of 100 g of this roasted barley was measured. Furthermore, 5 grains were arbitrarily selected, and the weight of each grain was measured. At the same time, the roasted barley was cut perpendicularly approximately at the center, and the measured void content was calculated. The results are presented in Table 3, and a photograph of the cross-section is presented in FIG. 3.

TABLE 3
Comparative Example 2
Average weight (g/grain) 0.028
Apparent volume (ml/grain) 0.053

| | Cross- | Cross- | | Occupancy | |
|---|---|---|---|---|---|
| | sectional | sectional | | of air holes | |
| | area of the | area of | | covering in | Measured |
| | entirety | air holes | | the entirety | void |
| No. | (μm²) | (μm²) | Hardness | (%) | content |
| 1 | 6214200 | 900139 | 1.5 kg | 14.49 | 0.8 |
| 2 | 6551142 | 538153 | 2.2 kg | 8.21 | 0.4 |
| 3 | 7457940 | 585254 | 3.2 kg | 7.85 | 0.4 |
| 4 | 5238333 | 114242 | 3.5 kg | 2.18 | 0.1 |
| 5 | 6672334 | 360112 | 3.3 kg | 5.40 | 0.3 |
| Ave | 6426790 | 499580 | 2.7 kg | 7.63 | 0.4 |

### Comparative Example 3

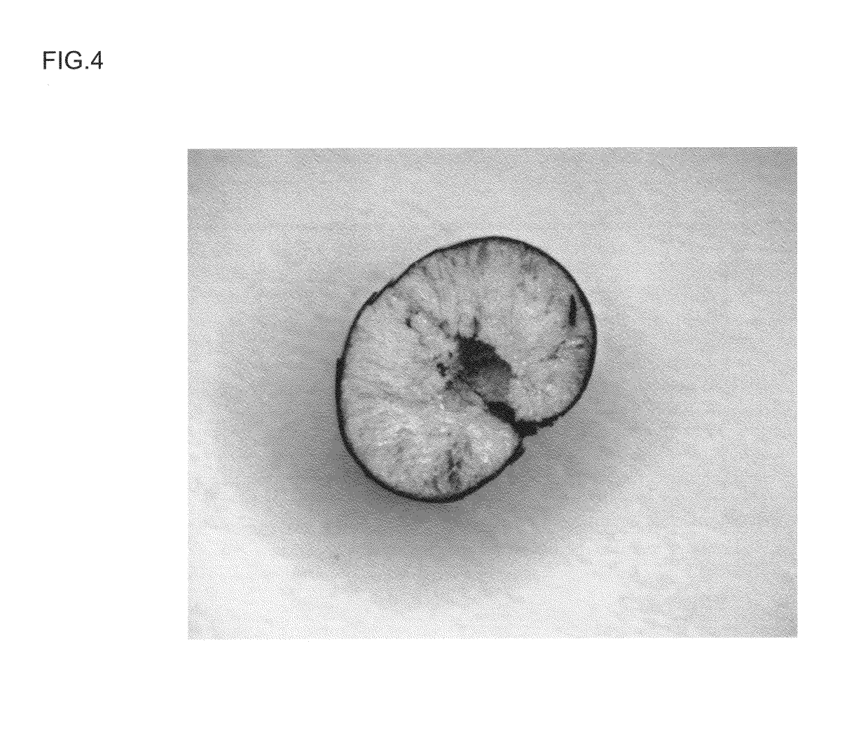

A package of 50 bags+2 bags of “Barley Tea Bag” manufactured by Katosangyo Co., Ltd. was used, which is a commercially available product, and the bulk specific gravity of 100 g of this roasted barley was measured. Whole materials (whole grain materials) were selected from the ground material of roasted barley, and 3 grains were arbitrarily selected and the weight of each grain was measured. At the same time, the roasted barley was cut perpendicularly approximately at the center, and the measured void content was calculated. The results are presented in Table 4, and a photograph of the cross-section is presented in FIG. 4.

TABLE 4
Comparative Example 3
Average weight (g/grain) 0.025
Apparent volume (ml/grain) 0.058

| | Cross- | Cross- | | Occupancy | |
|---|---|---|---|---|---|
| | sectional | sectional | | of air holes | |
| | area of the | area of | | covering in | Measured |
| | entirety | air holes | | the entirety | void |
| No. | (μm²) | (μm²) | Hardness | (%) | content |
| 1 | 2964100 | 57963 | 6.5 kg | 1.95 | 0.1 |
| 2 | 5100326 | 462639 | 1.3 kg | 9.07 | 0.5 |
| 3 | 3341669 | 141659 | 3.2 kg | 4.24 | 0.2 |
| Ave | 3802032 | 220754 | 3.6 kg | 5.09 | 0.3 |

### Comparative Example 4

“Tsubumaru” manufactured by Ogawa Sangyo Co. Ltd. was used, which is a commercially available product, and an evaluation test was carried out as follows.

(Sensory Evaluation)

2 g each of the roasted barley of Example 1 and Comparative Examples 1 to 4 were respectively ground and extracted with 200 cc of boiling water for 1 to 2 minutes. Each of the ground products was scooped up using a metal net having a mesh size of 0.5 mm, and the extraction liquid (barley tea) was separated from the ground product. Thus, the extraction liquids (barley tea) obtained from the roasted barley of Example 1 and Comparative Examples 1 to 4 were designated as barley teas 1 to 5, respectively.

These barley teas 1 to 5 were taken by drinking, and a sensory evaluation was carried out on the roasted savor, sweetness and richness.

The sensory evaluation was carried out such that each panelist made an evaluation on the roasted savor, sweetness and richness, and these properties were respectively rated as ⊚ (double circle) for being strongly sensed; as ◯ (circle) for being sensed; as Δ (triangle) for being slightly sensed; and as x (cross) for being hardly sensed. Five people who had been trained for sensory evaluation were selected as the panelists, and the most frequent ratings are presented in the following Table 5. Furthermore, the most frequent ratings for each of the evaluations on sweetness, roasted savor and richness were taken as the comprehensive ratings for the barley teas 1 to 5.

TABLE 5

| Sensory | Barley | Barley | Barley | Barley | Barley |
|---|---|---|---|---|---|
| evaluation | tea 1 | tea 2 | tea 3 | tea 4 | tea 5 |
| Sweetness | ⊚ | X | Δ | Δ | Δ |
| Roasted savor | ⊚ | Δ | X | X | Δ |
| Richness | ⊚ | X | X | X | Δ |
| Comprehensive | ⊚ | X | X | X | Δ |
| rating | | | | | |

(Results of Sensory Evaluation)

The barley tea 1 was rated as ⊚ (double circle) for all of the items. However, the barley teas 2 to 5 were weaker than the barley tea 1 in terms of the roasted savor, sweetness and richness, and were overall not satisfactory.

This is thought to be because the roasted barley of Example 1 has large internal voids and has been uniformly roasted, as can be seen from the measured void contents shown in the Tables 1 to 4, and therefore, the barley tea 1 extracted from that roasted barley is excellent in the roasted savor, sweetness and richness.

(Limit Load)

The roasted barleys of Example 1 and Comparative Examples 1 to 3 were used, and the limit load was measured as follows.

One whole grain each of the roasted barleys of Example 1 and Comparative Examples 1 to 3 was perpendicularly cut in the major axis direction and the minor axis direction to divide the whole grain into four equal parts, and the one-quarter cut grain was mounted on a platform. A wedge-type plunger was pressed against the cut grain on the platform from the above, and the plunger was descended at a speed of 20 mm/min until the cut grain ruptured. The maximum load at the point of rupture was measured as the limit load.

This measurement was performed using a digital force gauge “DPX-5TR” manufactured by Imada Co., Ltd.

This measurement was performed for 30 grains for each product. The results are presented in the following Table 6.

TABLE 6

| | | Comparative | Comparative | Comparative |
|---|---|---|---|---|
| | Example 1 | Example 1 | Example 2 | Example 3 |
| Average void | 2.0 | 0.4 | 0.4 | 0.3 |
| content | | | | |
| Average limit | 0.71 | 0.61 | 0.95 | 1.16 |
| load (N) | | | | |
| Standard | 0.20 | 0.29 | 0.38 | 0.46 |
| deviation | | | | |
| Distribution | 0.66 | 0.90 | 1.78 | 1.72 |
| range | | | | |
| (maximum | | | | |
| value − | | | | |
| minimum | | | | |
| value) | | | | |

(Results of Limit Load)

The roasted barley of Example 1 was confirmed to have a small standard deviation, a small difference between the maximum value and the minimum value, and a uniform limit load, and to have been uniformly roasted.

On the other hand, the roasted barleys of Comparative Examples 1 to 3 were confirmed to have large standard deviations and large differences between the maximum value and the minimum value, and to have been unevenly roasted.

(Difference in L Value)

The roasted barleys of Example 1 and Comparative Examples 1, 2 and 4 were used to measure the difference in the L value.

5 g each of the whole material of the roasted barleys of Example 1 and Comparative Examples 1, 2 and 4 was measured, and this amount was enclosed in a measurement cell. The L value was measured with a colorimeter (NIPPON DENSHOKU SE-2000, manufactured by Nippon Denshoku Co., Ltd.), and this value was designated as the L value of the whole material.

Subsequently, 10 g each of the whole materials of the roasted barleys of Example 1 and Comparative Examples 1, 2 and 4 was measured, and each of these whole materials was ground for 3 seconds with a hand mill (laboratory mixer LM-1). This ground material was classified with a sieve having a mesh size of 24, and 3 g of the ground material having a size of 24 mesh or less, which had been classified with a sieve, was metered. This ground material was enclosed uniformly in a measurement cell, and the L value was measured with a colorimeter (NIPPON DENSHOKU SE-2000, manufactured by Nippon Denshoku Co., Ltd.). This value was designated as the L value of the ground material. Furthermore, the difference between the L value of the whole material and the L value of the ground material was calculated, and the difference in the L value was determined. The results are presented in the following Table 7.

TABLE 7

| | | Comparative | Comparative | Comparative |
|---|---|---|---|---|
| | Example 1 | Example 1 | Example 2 | Example 4 |
| Average void | 2.0 | 0.4 | 0.4 | 0.5 |
| content | | | | |
| L value (whole | 20.51 | 19.36 | 20.72 | 23.98 |
| material) | | | | |
| L value (crude | 26.19 | 27.76 | 27.77 | 32.20 |
| ground material) | | | | |
| Difference in L | 5.68 | 8.40 | 7.05 | 8.22 |
| value | | | | |
| Rate of change | 1.28 | 1.43 | 1.34 | 1.34 |
| in L value | | | | |

(Results of Difference in L Value)

It was confirmed that the roasted barley of Example 1 had a small difference in the L value, while the Comparative Examples 1, 2 and 4 had large differences in the L value.

From these results, it is thought that the roasted barley of Example 1 had a small difference in the L value, was uniformly roasted, and was excellent in the roasted savor, sweetness and richness.

It is considered that the difference in the L value is preferably 6.5 or less, as examined from the values of Example 1 and Comparative Examples 1, 2 and 4.

(Rapid Cooling Step)

Subsequently, an investigation was made on what temperature difference is appropriate in the rapid cooling step.

2 g of a roasted barley produced by changing the temperature difference in the rapid cooling step used in the production method of Example 1, as indicated in the following Table 8, was ground and extracted with 200 cc of boiling water for 1 to 2 minutes. The ground material and the extraction liquid were separated using a metal net having a mesh size of 0.5 mm, and this extraction liquid was taken by drinking. Thus, a sensory evaluation on the sweetness, richness and roasted savor was carried out in the same manner as the sensory evaluation described above. These results are presented in the following Table 8.

TABLE 8
<Evaluation results>

| | Rapid cooling temperature | | | | | | | | | | |
|---|---|---|---|---|---|---|---|---|---|---|---|
| | 0° | 30° | 45° | 60° | 80° | 90° | 100° | 115° | 130° | 148° | 165° |
| | C. | C. | C. | C. | C. | C. | C. | C. | C. | C. | C. |
| Comprehensive | X | X | X | Δ | ⊚ | ⊚ | ◯ | Δ | Δ | X | X |
| sensory | | | | | | | | | | | |
| evaluation | | | | | | | | | | | |

Items of comprehensive evaluation

| | | | | | | | | | | | |
|---|---|---|---|---|---|---|---|---|---|---|---|
| Sweetness | X | X | X | Δ | ⊚ | ⊚ | ◯ | ◯ | Δ | Δ | X |
| Richness | X | X | X | Δ | ⊚ | ⊚ | ◯ | Δ | Δ | X | X |
| Roasted savor | Δ | Δ | Δ | Δ | ⊚ | ⊚ | ◯ | Δ | Δ | X | X |

(Slow Cooling Step)

Subsequently, an investigation was made on what is an appropriate retention in seconds for the material temperature of barley to be retained in the temperature range of 140 to 80° C. in the slow cooling step.

2 g of a roasted barley produced by changing the retention time in the slow cooling step used in the production method of Example 1, as indicated in the following Table 9, was ground and extracted with 200 cc of boiling water for 1 to 2 minutes. The ground material and the extraction liquid were separated using a metal net having a mesh size of 0.5 mm, and this extraction liquid was taken by drinking. Thus, a sensory evaluation on the sweetness, richness and roasted savor was carried out in the same manner as the sensory evaluation described above. These results are presented in the following Table 9.

TABLE 9
<Evaluation results>

| | Retention time (material temperature of barley 140 to 80° C.) | | | | | | | | | | | | |
|---|---|---|---|---|---|---|---|---|---|---|---|---|---|
| | 9 | 13 | 16 | 20 | 27 | 60 | 90 | 120 | 150 | 180 | 300 | 420 | 600 |
| | sec. | sec. | sec. | sec. | sec. | sec. | sec. | sec. | sec. | sec. | sec. | sec. | sec. |
| Comprehensive | X | Δ | Δ | ◯ | ⊚ | ⊚ | ◯ | ◯ | Δ | X | X | X | X |
| sensory | | | | | | | | | | | | | |
| evaluation | | | | | | | | | | | | | |

Items of comprehensive evaluation

| | | | | | | | | | | | | | |
|---|---|---|---|---|---|---|---|---|---|---|---|---|---|
| Sweetness | X | Δ | ◯ | ◯ | ⊚ | ⊚ | ◯ | ◯ | Δ | X | X | X | X |
| Richness | X | Δ | Δ | Δ | ⊚ | ⊚ | ◯ | ◯ | Δ | X | X | X | X |
| Roasted savor | Δ | Δ | Δ | ◯ | ◯ | ◯ | ◯ | Δ | Δ | Δ | X | X | X |

(Results)

In the rapid cooling step, when the temperature was lowered to 60 to 130° C., the sweetness, richness and roasted savor resulting from roasting were augmented, and the sense of body was increased. On the other hand, it was found that when the material temperature of barley was retained in the temperature range of 140 to 80° C. for 16 to 120 seconds in the slow cooling step, the sweetness, richness and roasted savor resulting from roasting were enhanced.

The test was further carried out by setting the temperature drop in the rapid cooling at any value between 60° C. and 130° C., and setting the time for the barley to be retained at a material temperature in the temperature range of 140 to 80° C. at the respective numbers of seconds indicated in the table.

At this time, the sensory evaluation was carried out such that tea bags each having a size of 10 cm×9 cm were produced using a filter made of a heat sealing paper having a freeness of 17.5 seconds. Barley roasted under various conditions was ground, and the ground barley was filled in the tea bags in an amount of 10 g each.

One of the tea bags was immersed in 1000 ml of tap water at normal temperature and was left to stand for 2 hours. Then, the tea bag was shaken up and down 10 times, subsequently the tea bag was taken out from the liquid, and thus an extraction liquid (barley tea) was produced. The liquid was taken by drinking at normal temperature, and thus a sensory evaluation was carried out.

The evaluation was made on the sweetness, roasted savor and richness, and these properties were respectively rated as ⊚ (double circle) for being strongly sensed; as ◯ (circle) for being sensed; as Δ (triangle) for being slightly sensed; and as x (cross) for being hardly sensed. In addition, five people who had been trained for sensory evaluation were selected as the panelists, and the most frequent ratings are presented in the following Table 5. Furthermore, the most frequent ratings for each of the evaluations on sweetness, roasted savor and richness were taken as the comprehensive ratings for the Example 1 and Comparative Examples 1 to 4.

These results are presented in the following tables 10 to 15.

TABLE 10

| | | | Sensory evaluation | | | |
|---|---|---|---|---|---|---|
| | Temperature | | | | | Compre- |
| | reached by | Retention | Sweet- | Rich- | Roasted | hensive |
| No. | rapid cooling | time | ness | ness | savor | evaluation |
| 1 | Δ60° C. | 13 sec. | Δ | Δ | Δ | Δ |
| 2 | | 16 sec. | Δ | Δ | Δ | Δ |
| 3 | | 20 sec. | Δ | Δ | Δ | Δ |
| 4 | | 27 sec. | ◯ | ◯ | Δ | ◯ |
| 5 | | 60 sec. | ◯ | ◯ | Δ | ◯ |
| 9 | | 90 sec. | Δ | Δ | Δ | Δ |
| 7 | | 120 sec. | Δ | Δ | Δ | Δ |
| 8 | | 150 sec. | Δ | Δ | Δ | Δ |

TABLE 11

| | | | Sensory evaluation | | | |
|---|---|---|---|---|---|---|
| | Temperature | | | | | Compre- |
| | reached by | Retention | Sweet- | Rich- | Roasted | hensive |
| No. | rapid cooling | time | ness | ness | savor | evaluation |
| 9 | Δ80° C. | 13 sec. | ◯ | ◯ | ◯ | ◯ |
| 10 | | 16 sec. | ⊚ | ◯ | ◯ | ◯ |
| 11 | | 20 sec. | ⊚ | ◯ | ⊚ | ⊚ |
| 12 | | 27 sec. | ⊚ | ⊚ | ⊚ | ⊚ |
| 13 | | 60 sec. | ⊚ | ⊚ | ⊚ | ⊚ |
| 14 | | 90 sec. | ⊚ | ⊚ | ⊚ | ⊚ |
| 15 | | 120 sec. | ⊚ | ⊚ | ◯ | ⊚ |
| 16 | | 150 sec. | ◯ | ◯ | ◯ | ◯ |

TABLE 12

| | | | Sensory evaluation | | | |
|---|---|---|---|---|---|---|
| | Temperature | | | | | Compre- |
| | reached by | Retention | Sweet- | Rich- | Roasted | hensive |
| No. | rapid cooling | time | ness | ness | savor | evaluation |
| 17 | Δ90° C. | 13 sec. | ◯ | ◯ | ◯ | ◯ |
| 18 | | 16 sec. | ⊚ | ◯ | ◯ | ◯ |
| 19 | | 20 sec. | ⊚ | ◯ | ⊚ | ⊚ |
| 20 | | 27 sec. | ⊚ | ⊚ | ⊚ | ⊚ |
| 21 | | 60 sec. | ⊚ | ⊚ | ⊚ | ⊚ |
| 22 | | 90 sec. | ⊚ | ⊚ | ⊚ | ⊚ |
| 23 | | 120 sec. | ⊚ | ⊚ | ◯ | ⊚ |
| 24 | | 150 sec. | ◯ | ◯ | ◯ | ◯ |

TABLE 13

| | | | Sensory evaluation | | | |
|---|---|---|---|---|---|---|
| | Temperature | | | | | Compre- |
| | reached by | Retention | Sweet- | Rich- | Roasted | hensive |
| No. | rapid cooling | time | ness | ness | savor | evaluation |
| 25 | Δ100° C. | 13 sec. | Δ | Δ | Δ | Δ |
| 26 | | 16 sec. | ◯ | Δ | Δ | Δ |
| 27 | | 20 sec. | ◯ | Δ | ◯ | ◯ |
| 28 | | 27 sec. | ⊚ | ⊚ | ◯ | ⊚ |
| 29 | | 60 sec. | ⊚ | ⊚ | ◯ | ⊚ |
| 30 | | 90 sec. | ◯ | ◯ | ◯ | ◯ |
| 31 | | 120 sec. | ◯ | ◯ | Δ | ◯ |
| 32 | | 150 sec. | Δ | Δ | Δ | Δ |

TABLE 14

| | | | Sensory evaluation | | | |
|---|---|---|---|---|---|---|
| | Temperature | | | | | Compre- |
| | reached by | Retention | Sweet- | Rich- | Roasted | hensive |
| No. | rapid cooling | time | ness | ness | savor | evaluation |
| 33 | Δ115° C. | 13 sec. | Δ | Δ | Δ | Δ |
| 34 | | 16 sec. | ◯ | Δ | Δ | Δ |
| 35 | | 20 sec. | ◯ | Δ | Δ | Δ |
| 36 | | 27 sec. | ⊚ | ◯ | Δ | ◯ |
| 37 | | 60 sec. | ⊚ | ◯ | Δ | ◯ |
| 38 | | 90 sec. | ◯ | Δ | Δ | Δ |
| 39 | | 120 sec. | ◯ | Δ | Δ | Δ |
| 40 | | 150 sec. | Δ | Δ | Δ | Δ |

TABLE 15

| | | | Sensory evaluation | | | |
|---|---|---|---|---|---|---|
| | Temperature | | | | | Compre- |
| | reached by | Retention | Sweet- | Rich- | Roasted | hensive |
| No. | rapid cooling | time | ness | ness | savor | evaluation |
| 41 | Δ130° C. | 13 sec. | Δ | Δ | Δ | Δ |
| 42 | | 16 sec. | Δ | Δ | Δ | Δ |
| 43 | | 20 sec. | Δ | Δ | Δ | Δ |
| 44 | | 27 sec. | ◯ | ◯ | Δ | ◯ |
| 45 | | 60 sec. | ◯ | ◯ | Δ | ◯ |
| 46 | | 90 sec. | Δ | Δ | Δ | Δ |
| 47 | | 120 sec. | Δ | Δ | Δ | Δ |
| 48 | | 150 sec. | Δ | Δ | Δ | Δ |

As shown in the Tables 10 to 15, the barley teas produced by applying a temperature drop in the rapid cooling of 80 to 90° C. and a retention time in the temperature range of 140 to 80° C. of 27 to 60 seconds, had the sweetness and richness augmented and had the best sense of body.

<Production of Tea Bag>

Tea bags 1 to 5 were produced as follows, and these tea bags were used to perform a sensory evaluation.

(Tea Bag 1)

10 g of the roasted barley of Example 1 was ground with a grinder, and this ground product was enclosed in a filter made of a heat sealing paper (manufactured by Nippon Paper Papylia Co., Ltd.) having a basis weight of 21.2 g/m² and a freeness of 17.5 seconds. Thus, a tea bag 1 having a size of 10 cm×9 cm was produced.

(Tea Bag 2)

10 g of the roasted barley of Example 1 was ground with a grinder, and this ground product was enclosed in a filter made of a heat sealing paper (manufactured by Nippon Paper Papylia Co., Ltd.) having a basis weight of 21.5 g/m² and a freeness of 26.5 seconds. Thus, a tea bag 2 having a size of 10 cm×9 cm was produced.

(Tea Bag 3)

10 g of the roasted barley of Example 1 was ground with a grinder, and this ground product was enclosed in a filter made of a heat sealing non-woven fabric (manufactured by Ohki Co., Ltd.) having a basis weight of 19.1 g/m² and a freeness of 2.4 seconds. Thus, a tea bag 3 having a size of 10 cm×9 cm was produced.

(Tea Bag 4)

10 g of the roasted barley of Example 1 was ground with a grinder, and this ground product was enclosed in a nylon fiber mesh (manufactured by Fuso Industries Co., Ltd.) having a basis weight of 24.1 g/m² and a freeness of 1.8 seconds. Thus, a tea bag 4 having a size of 10 cm×9 cm was produced.

(Tea Bag 5)

10 g of the roasted barley of Example 1 was ground with a grinder, and this ground product was enclosed in a filter made of a heat sealing paper (manufactured by Nippon Paper Papylia Co., Ltd.) having a basis weight of 16.8 g/m² and a freeness of 11.1 seconds. Thus, a tea bag 5 having a size of 10 cm×9 cm was produced.

(Air Permeability)

The air permeability was measured by the Gurley test method (JIS P 8117). Twenty sheets of filter were superposed, and the number of seconds taken by 100 ml of air to permeate was measured.

(Basis Weight)

The basis weight was determined by cutting a filter to a square having a size of 5 cm on each side, measuring the weight, and performing calculation.

(Freeness)

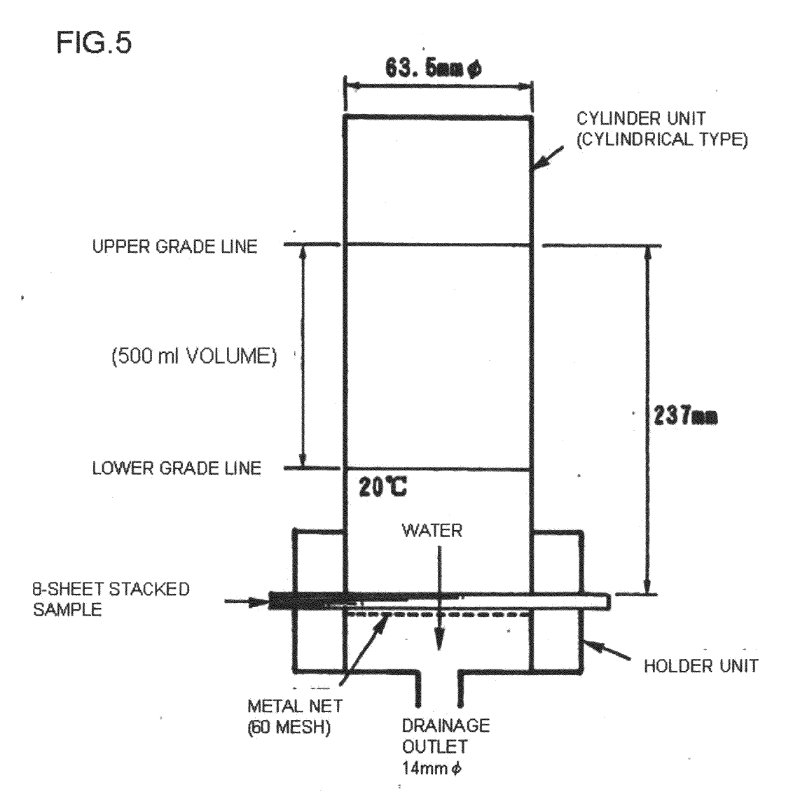

The freeness was determined by using the freeness tester shown in FIG. 5. First, a measurement sample is completely wetted with water at 20° C., and eight sheets are superposed while care is taken not to entrain air bubbles, and are set on a sample holder. Subsequently, the drainage outlet is closed, and water adjusted to 20° C. is poured until the level of water exceeds the upper grade line of the cylinder unit. Then, the drainage outlet is opened, and the time (seconds) taken by the water surface in the cylinder to pass the upper grade line and then to pass the lower grade line, was measured with a stopwatch.

(Sensory Evaluation)

The sensory evaluation was performed such that each tea bag was immersed in 1000 ml of tap water at normal temperature and was left to stand overnight in a refrigerator (5° C.). Subsequently, the tea bag was shaken up and down 10 times and taken out of water. The extraction liquid was taken by drinking.

The evaluation was carried out by ten ordinary panelists on the basis of 10-point ratings. The sweetness, roasted savor and richness were respectively rated based on 10 grades, given 10 points for being very strongly sensed and 1 point for being not sensed, and the aftertaste was rated based on 10 grades, given 10 points for being very good and 1 point for being very bad. Other unpleasant taste was rated based on 10 grades, given 1 point for being very strongly sensed and 10 points for not being sensed. The values obtained by averaging these ratings and then rounding off are presented in the following Table 16. The comprehensive evaluation was carried out by summing the respective ratings and grading 50 to 47 points as “⊚ (double circle)”; 46 to 43 points as “◯ (circle)”; 42 to 39 points as “Δ (triangle)”; and 38 points or less as “x (cross)”.

Furthermore, as the item “filterless”, 10 g of the roasted barley of Example 1 was ground with a grinder, and this ground product was immersed in 1000 ml of tap water at normal temperature and was left to stand overnight in a refrigerator (5° C.). Subsequently, the ground product was scooped up using a metal net having a mesh size of 0.5 mm. The extraction liquid was taken by drinking, and the same sensory evaluation as described above was performed.

TABLE 16

| | Properties data | | | | | | | | | |
|---|---|---|---|---|---|---|---|---|---|---|
| | Basis | Air | Free- | Sensory evaluation | | | | | | |
| | weight | permeability | ness | Sweet- | Roasted | Rich- | Unpleasant | After- | | Compre- |
| | (g/m²) | (seconds) | (seconds) | ness | savor | ness | taste | taste | Total | hensive |
| Filterless | — | — | — | 9 | 10 | 10 | 8 | 8 | 45 | ◯ |
| Tea bag 1 | 21.2 | 0.83 | 17.5 | 10 | 10 | 10 | 10 | 10 | 50 | ⊚ |
| Tea bag 2 | 21.5 | 1.02 | 26.5 | 7 | 6 | 6 | 10 | 10 | 40 | Δ |
| Tea bag 3 | 19.1 | 0.12 | 2.4 | 9 | 10 | 10 | 10 | 9 | 48 | ⊚ |
| Tea bag 4 | 24.1 | Unmeasurable* | 1.8 | 9 | 10 | 10 | 8 | 8 | 45 | ◯ |
| Tea bag 5 | 16.8 | 0.46 | 11.1 | 10 | 10 | 10 | 10 | 10 | 50 | ⊚ |

*Since tea bag 4 is a mesh type bag, the air permeability is illimitably close to zero

### Results

In the tea bags 1 and 5 produced using filters made of heat sealing papers having a freeness of 17.5 seconds and 11.1 seconds, and the tea bag 3 produced using a non-woven fabric filter having a freeness of 2.4 seconds, barley teas in which the unpleasant taste was hardly sensed, the aftertaste was good, and the flavor was more excellent, were obtained in spite of the conditions of slight over-extraction.

Therefore, it was able to be confirmed that when the roasted barley of the present invention or a ground product thereof is enclosed using a filter having a freeness of 2.0 seconds to 25.0 seconds, and a tea bag is produced, a barley tea that is more tasteful than a tea obtained by direct extraction, can be made.

1. Roasted barley having a measured void content per grain of 1.5 mL to 2.5 mL.

2. The roasted barley according to claim 1, having a hardness of 1.7 kg to 2.3 kg.

3. The roasted barley according to claim 1, wherein the difference between the L value of the whole material and the L value of the ground material is 6.5 or less.

4. A method of producing roasted barley, comprising, between a primary roasting step and a secondary roasting step, at least a rapid cooling step of rapidly lowering the material temperature of barley over a temperature difference of 60 to 130° C. within 5 seconds.

5. The method of producing roasted barley according to claim 4, comprising, after the secondary roasting step, a slow cooling step of retaining the material temperature of barley between 80° C. and 140° C. for 16 seconds to 120 seconds.

6. The method of producing roasted barley according to, claim 4, wherein the primary roasting step is a step of performing roasting at a roasting temperature of 225° C. to 290° C. for 60 seconds to 120 seconds, and the secondary roasting step is a step of performing roasting at a roasting temperature of 250° C. to 300° C. for 60 seconds to 120 seconds.

7. The method of producing roasted barley according to, claim 4, comprising, before the primary roasting step, a step of subjecting the raw material barley to a steam spray treatment to adjust the water content of barley to 14% to 30% and to expand the volume by 1% to 20%.

8. The method of producing roasted barley according to, claim 4, wherein the L value of the barley before being subjected to the rapid cooling step is 30 to 80, and the L value of the barley before being subjected to the slow cooling step is 15 to 65.

9. A tea bag produced by enclosing the roasted barley according to, claim 1, or a ground product of the roasted barley, in a filter.

10. A tea bag produced by enclosing the roasted barley obtainable by the method according to, claim 4, or a ground product of the roasted barley, in a filter.

11. A tea bag according to, claim 9, having a freeness of the filter of 2.0 seconds to 25.0 seconds.

12. A barley tea beverage packaged in a container, filled with the barley tea extracted from the roasted barley according to claim 1.

13. A barley tea beverage packaged in a container, filled with the barley tea extracted from the roasted barley obtainable by the method according to claim 4.

14. (canceled)

15. An apparatus for producing roasted barley, comprising a primary roasting chamber in which primary roasting is performed at a roasting temperature of 225 to 290° C. for 60 to 120 seconds; a secondary roasting chamber in which secondary roasting is performed at a roasting temperature of 250 to 300° C. for 60 to 120 seconds; and a liquid or gas spraying apparatus for performing rapid cooling, disposed near the outlet of this primary roasting chamber or outside the primary roasting chamber.

16. The apparatus for producing roasted barley according to, claim 14, further comprising a steam spray treatment chamber in which the raw material barley is subjected to a steam spray treatment to adjust the water content of barley to 14% to 30% and to expand the volume of barley by 1% to 20%.
